(19) United States
(12) Patent Application Publication
(10) Pub. No.: US 2024/0123863 A1
(43) Pub. Date: Apr. 18, 2024

(54) APPARATUS FOR MANAGEMENT A DRIVING DISTANCE OF AN ELECTRIC VEHICLE AND METHOD THEREOF

(71) Applicants: Hyundai Motor Company, Seoul (KR); Kia Corporation, Seoul (KR)

(72) Inventor: Un CHON, Seongnam-Si (KR)

(73) Assignees: Hyundai Motor Company, Seoul (KR); Kia Corporation, Seoul (KR)

(21) Appl. No.: 18/201,969

(22) Filed: May 25, 2023

(30) Foreign Application Priority Data
Oct. 14, 2022 (KR) 10-2022-0132395

(51) Int. Cl. B60L 58/12; B60L 1/02; B60L 15/20

(52) U.S. Cl. CPC B60L 58/12; B60L 1/02; B60L 15/20

(57) ABSTRACT

A mileage management apparatus for an electric vehicle, includes a processor configured to determine whether the vehicle can complete a travel to a destination thereof by use of a mileage based on a state of charge (SOC) value of a high voltage battery, to limit power consumption of a load having a voltage higher than a predetermined voltage when the processor concludes that the vehicle cannot complete the travel, and to drive a load having a voltage lower than the predetermined voltage depending on a degree of a decrease in an indoor temperature of the vehicle to provide heat to a user, and an interface device communicatively connected to the processor and configured to display whether the completion of the travel is possible.

### CROSS-REFERENCE TO RELATED APPLICATION

The present application claims priority to Korean Patent Application No. 10-2022-0132395, filed on Oct. 14, 2022, the entire contents of which is incorporated herein for all purposes by this reference.

### BACKGROUND OF THE PRESENT DISCLOSURE

### Field of the Present Disclosure

The present disclosure relates to a mileage management apparatus for an electric vehicle and a method thereof, and more particularly, to a technique for cooperatively controlling a load in the vehicle by determining a mileage of the electric vehicle.

### Description of Related Art

For electric vehicles, a mileage sharply decreases when a PTC heater (a fan heater for indoor heating) is used in winter. Accordingly, in a conventional electric vehicle, when a state of charge (SOC) value of a high voltage battery is smaller than 10%, the heater for indoor heating is turned off or a number of stages (Low/Mid/High) is lowered to increase battery lifespan.

Thus, the battery lifespan may be increased by reducing consumption of a heating heat source, but an internal temperature of the vehicle may be rapidly lowered, which causes a user to feel cold and complain about quality.

Furthermore, in the case of using a heater in winter, currently, it is not sure how far the vehicle can travel to a destination compared to a remaining battery capacity, and thus it is not possible to know whether it is possible to complete a travel to the destination, and thus there was a problem that a user feels uneasy about it.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a mileage management apparatus and method for an electric vehicle, configured for increasing satisfaction of a user by notifying the user whether it is possible to complete a travel to a destination while using a heat source when the electric vehicle is driven in winter.

Furthermore, an exemplary embodiment of the present disclosure has been made in an effort to provide a mileage management apparatus and method for an electric vehicle, configured for increasing user satisfaction through cooperative control of a heat wire load, which is a conductive heat source by limiting a load having the voltage higher than the predetermined voltage to increase a mileage of the electric vehicle in winter.

The technical objects of the present disclosure are not limited to the objects mentioned above, and other technical objects not mentioned may be clearly understood by those skilled in the art from the description of the claims.

An exemplary embodiment of the present disclosure provides a mileage management apparatus for an electric vehicle, including: a processor configured to determine whether it is possible to complete a travel to a destination thereof by use of a mileage based on a state of charge (SOC) of a high voltage battery, to limit power consumption of a load having a voltage higher than a predetermined voltage when the processor concludes that the vehicle cannot complete the travel, and to drive a load having a voltage lower than the predetermined voltage depending on a degree of a decrease in an indoor temperature of the vehicle to provide heat to a user, and an interface device communicatively connected to the processor and configured to display whether the completion of the travel is possible.

In an exemplary embodiment of the present disclosure, the interface device may be configured to output a possibility of the completion in a form of a pop-up message.

In an exemplary embodiment of the present disclosure, the processor may be configured to enter a range mode for increasing a mileage based on the SOC value of the high voltage battery when the processor concludes that the completion of the travel is impossible.

In an exemplary embodiment of the present disclosure, the processor, during autonomous driving of the vehicle or when the destination of the vehicle is set, is configured to conclude that the vehicle cannot complete the travel when the mileage based on the SOC value of the high voltage battery is shorter than a distance to the destination.

In an exemplary embodiment of the present disclosure, the processor, during manual driving or when the destination is not set, may be configured to conclude that the processor cannot determine whether the vehicle can complete the travel to the destination.

In an exemplary embodiment of the present disclosure, the processor during manual driving or when the destination is not set, may be configured to enter the range mode when a driving mode is set as the range mode and inputted by the user.

In an exemplary embodiment of the present disclosure, the processor, when entering the range mode,

when the SOC value of the high voltage battery is greater than or equal to a first reference value, may be configured to correct a path of the vehicle to enable the vehicle to move to a nearby charging station.

In an exemplary embodiment of the present disclosure, the processor may be configured to active an economical mode that limits power consumption of the load having the voltage higher than the predetermined voltage when the SOC value of the high voltage battery is equal to or greater than a second reference value which is smaller than the first reference value.

In an exemplary embodiment of the present disclosure, the processor, when the SOC value of the high voltage battery is smaller than a second reference value and smaller than a third reference value which is smaller than the second reference value, may configured to cut off power of an electronic load among the load having the voltage higher than the predetermined voltage and the load having the voltage lower than the predetermined voltage, and to turn on a warning lamp of the vehicle.

In an exemplary embodiment of the present disclosure, the processor, when the SOC value of the high voltage battery is greater than or equal to a third reference value and smaller than the second reference value, which is smaller than the first reference value, may be configured to activate the economical mode, and to decrease an indoor temperature setting value.

In an exemplary embodiment of the present disclosure, the processor, when a current indoor temperature is lower than a previously set indoor temperature setting value by less than a predetermined reference value, may be configured to perform step 1 of a power saving mode of automatically activating a driver seat heating wire and a steering wheel heating wire.

In an exemplary embodiment of the present disclosure, the processor, when a current indoor temperature is lower than a previously set indoor temperature setting value by equal to or greater than a predetermined reference value, may be configured to automatically activate a driver seat heating wire and a steering wheel heating wire, and to perform step 2 of a power saving mode of performing at least one of outdoor air blocking, indoor air conversion, and controlling all windows of the vehicle to be closed.

In an exemplary embodiment of the present disclosure, the processor, during an operation of the range mode, may be configured to release the range mode when manual operation of at least one of an operation of an air conditioning controller, window opening, turning-on of a defrost, changing of a driving mode is performed by the user.

In an exemplary embodiment of the present disclosure, the power consumption limit of the load having the voltage higher than the predetermined voltage may include at least one of a vehicle speed limit, a braking control, and an air conditioner off control.

In an exemplary embodiment of the present disclosure, the load having the voltage lower than the predetermined voltage may include at least one of a front deicer, a steering wheel heater, a seat warmer, a window heating wire, and a sunroof glass heating wire.

In an exemplary embodiment of the present disclosure, the processor, when it is impossible to determine whether it is possible to complete the travel, based on the SOC value of the high voltage battery, may be configured to determine a stage of the range mode for increasing the mileage based on the SOC value of the high voltage battery.

In an exemplary embodiment of the present disclosure, the processor, may be configured to limit a vehicle speed when the SOC value of the high voltage battery is greater than or equal to a first reference value, to limit the vehicle speed and gradually decrease an indoor temperature setting value when the SOC value of the high voltage battery is smaller than the first reference value and greater than or equal to a second reference value which is smaller than the first reference value, and to limit the vehicle speed and gradually decrease the indoor temperature setting value, but to activate seat heating and steering wheel heating when the SOC value of the high voltage battery is smaller than the second reference value and greater than or equal to a third reference value which is smaller than the second reference value.

In an exemplary embodiment of the present disclosure, the processor, when entering the range mode, may be configured to turn off air conditioning of second and third rows of the vehicle, and to drive air conditioning of a driver seat in the vehicle.

In an exemplary embodiment of the present disclosure, the interface device may be configured to display an indoor temperature setting value before entering the range mode, and to remove the display of the indoor temperature setting value after entering the range mode.

An exemplary embodiment of the present disclosure provides a mileage management method for an electric vehicle, including: determining, by a processor, whether it is possible to complete a travel to a destination thereof by use of a mileage based on a state of charge (SOC) value of a high voltage battery; limiting, by the processor, power consumption of a load having the voltage higher than the predetermined voltage when it is impossible to complete the travel; and driving, by the processor, a load having a voltage lower than the predetermined voltage depending on a degree of a decrease in an indoor temperature of the vehicle to provide heat to a user.

According to the present technique, it is possible to increase satisfaction of a user by notifying the user whether it is possible to complete a travel to a destination while using a heat source when the electric vehicle is driven in winter.

Furthermore, according to the present technique, it is possible to increase user satisfaction through cooperative control of a heat wire load, which is a conductive heat source by limiting a load having the voltage higher than the predetermined voltage to increase a mileage of the electric vehicle in winter.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing a configuration of a vehicle system including a mileage management apparatus for an electric vehicle according to an exemplary embodiment of the present disclosure.

FIG. 2 illustrates an example of a screen for a driving mode button according to an exemplary embodiment of the present disclosure.

FIG. 3 illustrates an example of a screen for a state transition of a driving mode button according to an exemplary embodiment of the present disclosure.

FIG. 4 illustrates an example of a screen on which a driving mode is displayed through a vehicle cluster according to an exemplary embodiment of the present disclosure.

FIG. 5 illustrates an example of a screen for setting a driving mode through an interface device according to an exemplary embodiment of the present disclosure.

FIG. 6 illustrates an example of driving for each driving mode of a mileage management apparatus for an electric vehicle according to an exemplary embodiment of the present disclosure.

FIG. 7 illustrates an example of a screen showing a battery state and a mileage according to an exemplary embodiment of the present disclosure.

FIG. 8 illustrates an example of a screen for displaying a temperature of an indoor air conditioner according to an exemplary embodiment of the present disclosure.

FIG. 9 illustrates a view for describing how a mileage is improved during a range mode according to an exemplary embodiment of the present disclosure.

FIG. 10 illustrates a flowchart for describing a mileage management method for an electric vehicle according to exemplary embodiment of the present disclosure.

FIG. 11 illustrates a flowchart for describing a mileage management method for an electric vehicle when it is impossible to determine whether or not a travel is completed according to exemplary embodiment of the present disclosure.

FIG. 12 illustrates a computing system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

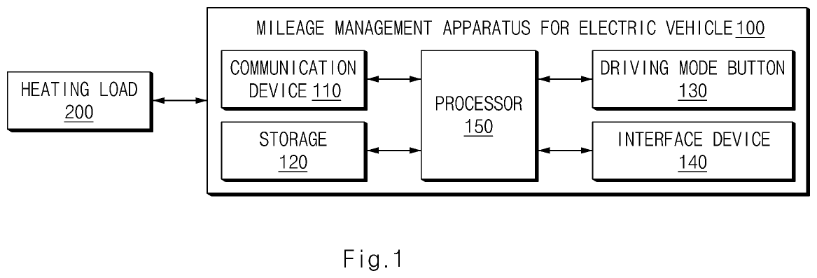

Hereinafter, various exemplary embodiments of the present disclosure will be described in detail with reference to FIG. 1 to FIG. 12.

FIG. 1 illustrates a block diagram showing a configuration of a vehicle system including a mileage management apparatus for an electric vehicle according to an exemplary embodiment of the present disclosure.

Referring to FIG. 1, the vehicle system according to the exemplary embodiment of the present disclosure may include a mileage management apparatus 100 for an electric vehicle, and a heating load 200.

The mileage management apparatus 100 according to an exemplary embodiment of the present disclosure may be implemented inside or outside the vehicle. In the instant case, the mileage management apparatus 100 may be integrally formed with internal control units of the vehicle, or may be implemented as a separate hardware device to be connected to control units of the vehicle by a connection means. For example, the mileage management apparatus 100 may be implemented integrally with the vehicle, may be implemented in a form which is installed or attached to the vehicle as a configuration separate from the vehicle, or a part thereof may be implemented integrally with the vehicle, and another part may be implemented in a form which is installed or attached to the vehicle as a configuration separate from the vehicle.

The mileage management apparatus 100 may be configured to determine whether it is possible to complete a travel to a destination thereof by use of a mileage based on a state of charge (SOC) value of a high voltage battery, may limit power consumption of a high voltage load when it is impossible to complete the travel, and may drive a load having a voltage lower than the predetermined voltage depending on a degree of a decrease in an indoor temperature of the vehicle to provide heat to a user.

The mileage management apparatus 100 may automatically switch a driving mode, or may control driving of the vehicle depending on the driving mode manually inputted from the user.

In the instant case, the driving mode may include a normal mode, which is a comfort mode, a sports mode to increase instantaneous acceleration, a snow mode to help prevent slipping on a snowy road, a terrain mode to help prevent slipping on a road surface such as rain or ice, a boost mode to improve power and acceleration responsiveness for a specific time period by use of maximum performance, and a range mode, etc.

The range mode is a mode that determines whether the mileage based on the state of charge (SOC) state of the high voltage battery is drivable to the destination, and performs vehicle speed limiting, high voltage heating load limiting, etc. to preserve the SOC value of the high voltage battery when driving in winter. The range mode may include an economical mode, a first step of a power saving mode, a second step of the power saving mode, and a third step of the power saving mode, which will be described in more detail later.

The heating load 200, which is a 12V heating load, includes a front deicer, a defrost, a heater, a steering wheel heater, a seat warmer, a window, and a sunroof glass. The processor 150 may differently set an on or off weight and an on or off time of each load based on the SOC value of the high voltage battery.

The mileage management apparatus 100 may include a communication device 110, a storage 120, a driving mode button 130, an interface device 140, and a processor 150.

The communication device 110 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include Controller Area Network (CAN) communication, Local Interconnect Network (LIN) communication, flex-ray communication, and the like.

Furthermore, the communication device 110 may perform communication by use of a server, infrastructure, or third vehicles outside the vehicle, and the like through a wireless Internet access or short range communication technique. Herein, the wireless communication technique may include wireless LAN (WLAN), Wireless Broadband (WiBro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like.

As an exemplary embodiment of the present disclosure, the communication device 110 may communicate with constituent elements such as the heating load 200 and the driving mode button 130.

The storage 120 may store data and/or algorithms required for the processor 150 to operate, and the like.

As an exemplary embodiment of the present disclosure, the storage 120 may store a reference value for determining the SOC value of the high voltage battery in the range mode in advance determined by an experimental value.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

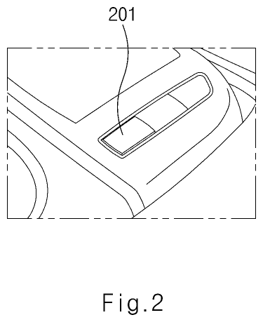

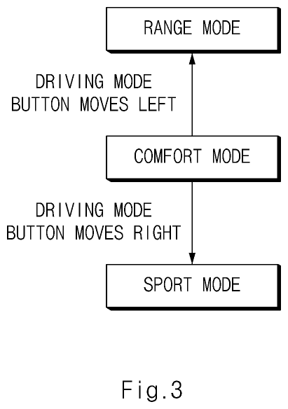

The driving mode button 130 may be manipulated by a user to change the driving mode. The driving mode may be set through the interface device 140 instead of the driving mode button 130. FIG. 2 illustrates an example of a screen for a driving mode button according to an exemplary embodiment of the present disclosure, and FIG. 3 illustrates an example of a screen for a state transition of a driving mode button according to an exemplary embodiment of the present disclosure. Referring to FIG. 2, a driving mode may be selected by moving a driving mode button 201 by a user. However, it is not limited to the driving mode button of the form illustrated in FIG. 2, and may be implemented as a button of various types (e.g., a pressing type, etc.). In FIG. 3, an example is included in which when the driving mode button 201 is moved to the left while the vehicle is driving in a comfort mode, the comfort mode is converted to a range mode, and when the driving mode button 201 is moved to the right, the comfort mode is converted to a sports mode. Such a driving mode conversion example is not limited thereto.

The interface device 140 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 140 may be implemented as a head-up display (HUD), a cluster, an audio video navigation (AVN), or a human machine interface (HM), a human machine interface (HMI).

The output device may include a display, and may also include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), a 3D display, or any combination thereof.

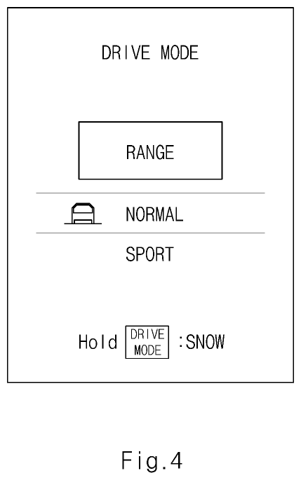

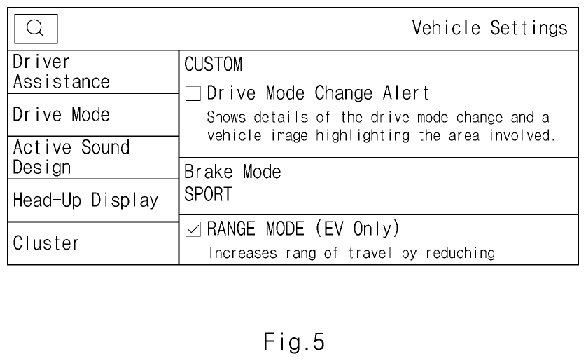

For example, the interface device 140 may receive the driving mode inputted from a user, and may display the current driving mode so that the user can check it. FIG. 4 illustrates an example of a screen on which a driving mode is displayed through a vehicle cluster according to an exemplary embodiment of the present disclosure, and FIG. 5 illustrates an example of a screen for setting a driving mode through an interface device according to an exemplary embodiment of the present disclosure. FIG. 4 illustrates an example in which a range mode is selected. In FIG. 5, as a setting screen for receiving a selection of a driving mode, an example in which a check box of a range mode is checked and selected by a user by a touch method is disclosed.

Furthermore, the interface device 140 may display whether it is possible to complete a travel to a destination, a graph of a mileage, a set temperature of an indoor air conditioner, a current indoor temperature, and the like.

The processor 150 may be electrically connected to the communication device 110, the storage 120, the interface device 140, and the like, may electrically control each component, and may be an electrical circuit that executes software commands, performing various data processing and determinations described below.

The processor 150 may perform overall control so that each component can normally perform their functions by processing a signal transferred between each component of the mileage management apparatus 100.

The processor 150 may be implemented in a form of hardware, software, or a combination of hardware and software. The processor 130 may be implemented as a microprocessor, but the present disclosure is not limited thereto, and may be an electronic control unit (ECU), a micro controller unit (MCU), or other subcontrollers mounted in the vehicle.

The processor 150 may be configured to determine whether it is possible to complete a travel to a destination thereof by use of a mileage based on a state of charge (SOC) value of a high voltage battery, may limit power consumption of a high voltage load when it is impossible to complete the travel, and may drive a load having a voltage lower than the predetermined voltage depending on a degree of a decrease in an indoor temperature of the vehicle to provide heat to a user.

In the instant case, the power consumption limit of the high voltage load may include at least one of a vehicle speed limit, a braking control, and an air conditioner off control.

Furthermore, the load having the voltage lower than the predetermined voltage may include at least one of a front deicer, a steering wheel heater, a seat warmer, a window heating wire, and a sunroof glass heating wire.

The processor 150 may output whether the completion of the travel is possible in a form of a pop-up message.

The processor 150 may enter the range mode for increasing the mileage based on the SOC value of the high voltage battery when the processor concludes that the completion of the travel is impossible.

During autonomous driving of the vehicle or when the destination of the vehicle is set, when a mileage based on the SOC value of the high voltage battery is shorter than a distance to the destination, the processor 150 may be configured to determine that it is impossible to complete the travel.

The processor 150 may be configured to determine whether it is possible to complete the travel during manual driving or when the destination is not set.

The processor 150 is configured to enter the range mode when the driving mode is set as the range mode by a user during manual driving or when the destination is not set.

When the processor 150 enters the range mode, when the SOC value of the high voltage battery is equal to or greater than a first reference value (e.g., 50° C.), the processor 150 may correct a path so that the vehicle moves to a nearby charging station.

When the SOC value of the high voltage battery is equal to or greater than a second reference value (e.g., 30° C.) and smaller than the first reference value, the processor 150 may activate an economical mode that limits power consumption of a high voltage load.

When the SOC value of the high voltage battery is smaller than the second reference value and smaller than a third reference value (e.g., 10° C.) which is smaller than the second reference value, the processor 150 may cut off power of an electronic load among the high voltage load and the load having the voltage lower than the predetermined voltage, and may turn on a warning lamp of the vehicle.

When the SOC value of the high voltage battery is greater than or equal to the third reference value and smaller than the second reference value, which is smaller than the first reference value, the processor 150 may activate the economical mode, and may gradually decrease an indoor temperature setting value.

When a current indoor temperature is lower than a previously set indoor temperature setting value by less than a predetermined reference value, the processor 150 may perform step 1 of a power saving mode of automatically activating a driver seat heating wire and a steering wheel heating wire.

When the current indoor temperature is lower than the previously set indoor temperature setting value by equal to or greater than the predetermined reference value, the processor 150 may automatically activate the driver seat heating wire and the steering wheel heating wire, and may perform step 2 of the power saving mode of performing at least one of outdoor air blocking, indoor air conversion, and controlling all windows of the vehicle to be closed.

The processor 150 may release the range mode when manual operation of at least one of an operation of an air conditioning controller, window opening, turning-on of a defrost, changing of a driving mode is performed by the user.

When it is impossible to determine whether the travel may be completed, the processor 150 may be configured to determine a stage of the range mode for increasing the mileage based on the SOC value of the high voltage battery based on the SOC value of the high voltage battery.

The processor 150 may limit a vehicle speed when the SOC value of the high voltage battery is greater than or equal to a first reference value, may limit the vehicle speed and gradually decrease an indoor temperature setting value when the SOC value of the high voltage battery is smaller than the first reference value and greater than or equal to a second reference value which is smaller than the first reference value, and may limit the vehicle speed and gradually decrease the indoor temperature setting value, but may activate seat heating and steering wheel heating when the SOC value of the high voltage battery is smaller than the second reference value and greater than or equal to a third reference value which is smaller than the second reference value.

When entering the range mode, the processor 150 may turn off the air conditioning of second and third rows of the vehicle, and may drive the air conditioning of a driver seat in the vehicle.

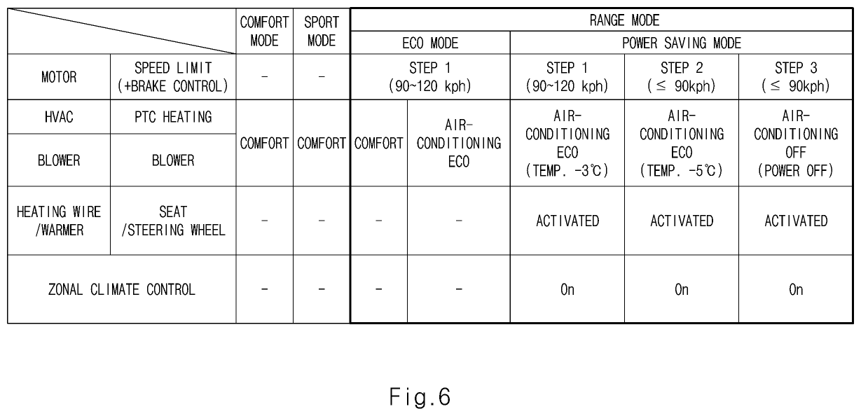

FIG. 6 illustrates an example of driving for each driving mode of a mileage management apparatus for an electric vehicle according to an exemplary embodiment of the present disclosure.

In FIG. 6, a comfort mode, a sports mode, and a motor for each range mode, HVAC (heating, ventilating & air conditioning), a blower, a heating wire/warmer, and temperature control for each area are disclosed. Furthermore, the range mode may be divided into an economical mode and a power saving mode (step 1, step 2, and step 3).

In the economical mode, the vehicle speed may be limited and the air conditioning control may be performed the same as in the comfort mode, or it may be performed in an air conditioning economical mode. In the air conditioning economical mode, an output of a high voltage heating load is limited.

In step 1 of the power saving mode, the air conditioning economical mode is activated, which controls the output of the high voltage heating load, when the indoor temperature drops by more than a predetermined reference value (e.g., −3° C.), to provide a user with a sense of warmth, a seat heating wire and a steering wheel heating wire are activated as a 12V auxiliary heat source load.

In step 2 of the power saving mode, the air conditioning economical mode is activated, but when the indoor temperature drops more than a predetermined reference value (e.g., −5° C.), to provide users with a sense of warmth, the seat heating wire and the steering wheel heating wire are activated as the 12V auxiliary heat source load (electronic comfort load), and outdoor air blocking, indoor air conversion, and controlling all windows of the vehicle to be closed are performed.

In step 3 of the power saving mode, all 12V auxiliary heat source loads (electronic convenience loads) are also cut off and all high voltage heating loads (e.g., heaters) are powered down (power is cut off), and a warning light is turned on.

Furthermore, in step 1 of the power saving mode, step 2 of the power saving mode, and step 3 of the power saving mode, a zonal climate control function is activated. That is, temperature control for each area may include turning off the air conditioning of second and third rows of the vehicle seat and turning on the air conditioning only for a driver seat in the vehicle.

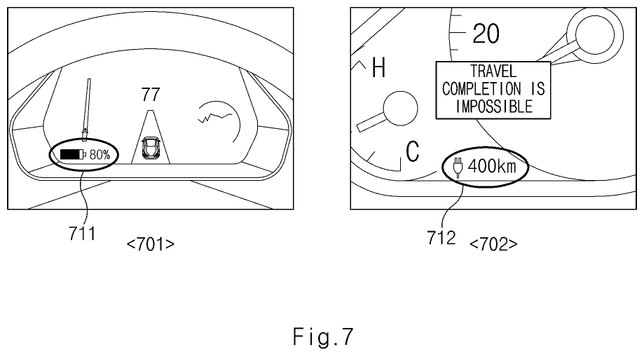

FIG. 7 illustrates an example of a screen showing a battery state and a mileage according to an exemplary embodiment of the present disclosure.

701 of FIG. 7 indicates an SOC 711 of a battery when driving in a comfort mode (normal mode) or a sports mode. Thereafter, when the vehicle enters the range mode, as shown in 702, a mileage 712 may be displayed and a “completion possible” pop-up may be outputted. That is, when the mileage 712 is displayed at the beginning of driving, that is, when driving in the comfort mode (normal mode) or the sports mode, the mileage 712 may change depending on circumstances such as ON/OFF of heating and cooling while driving, intensity of heating and cooling, and the like. Accordingly, a user may check more accurate mileage information by displaying the mileage 712 after changing to the range mode, determining whether or not to complete the travel to the destination.

Accordingly, the present disclosure is not limited to simply displaying the remaining battery capacity or the drivable distance but displays a remaining battery capacity in the sports mode or the comfort mode, and in the instant case, when the range mode is entered, the mileage may be displayed to allow to a user to intuitively understand whether it is possible to complete the travel to the destination while driving, increasing user satisfaction.

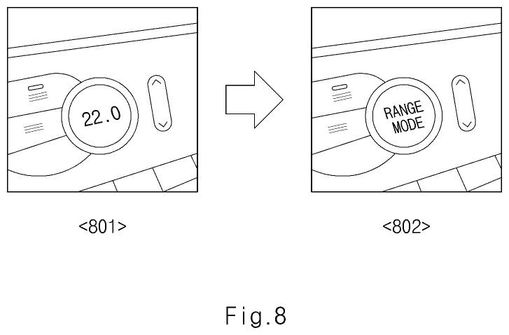

FIG. 8 illustrates an example of a screen for displaying a temperature of an indoor air conditioner according to an exemplary embodiment of the present disclosure.

Referring to 801 of FIG. 8, when the air conditioner is driven while driving in the comfort mode (normal mode) or the sports mode, a set temperature (e.g., 22 degrees) is displayed.

However, as in 802, when it is switched to range mode, it removes the set temperature and displays “Range Mode” instead to inform the user that it is being driven in the range mode. That is, in the range mode, the mileage may be increased by driving at a temperature which is lower than the set temperature for heating by −3 degrees or −5 degrees, to prevent discrepancy between the set temperature that the user may feel and an actual air conditioning temperature, it indicates that it is operating in the range mode without displaying a numerical value of the set temperature.

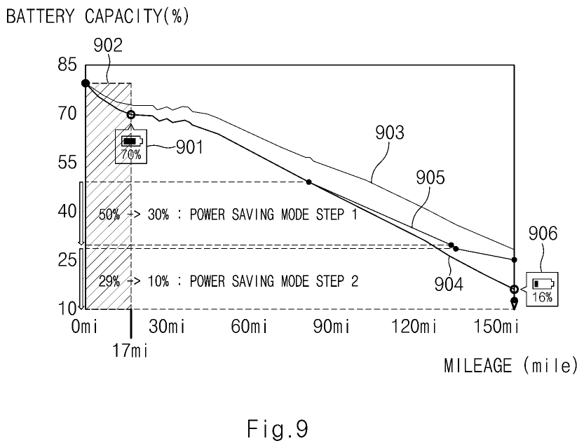

FIG. 9 illustrates a view for describing how a mileage is improved during a range mode according to an exemplary embodiment of the present disclosure.

Referring to FIG. 9, the mileage management apparatus 100 for an electric vehicle may be configured to determine a mileage 903 based on an SOC 901 of a battery at beginning of driving. However, when driving environment variables such as an outdoor temperature and an uphill slope are reflected after driving starts (902), the mileage may be shortened (904).

Accordingly, in an exemplary embodiment of the present disclosure, it may be seen that the mileage management apparatus 100 operates in the range mode to improve a mileage 905. In the instant case, it may be seen that an improvement rate of the mileage is increased in a case of driving in step 2 of the power saving mode compared to a case of driving in step 1 of the power saving mode. The mileage management apparatus 100 may be configured to predict a remaining battery capacity 906 upon arrival at the destination.

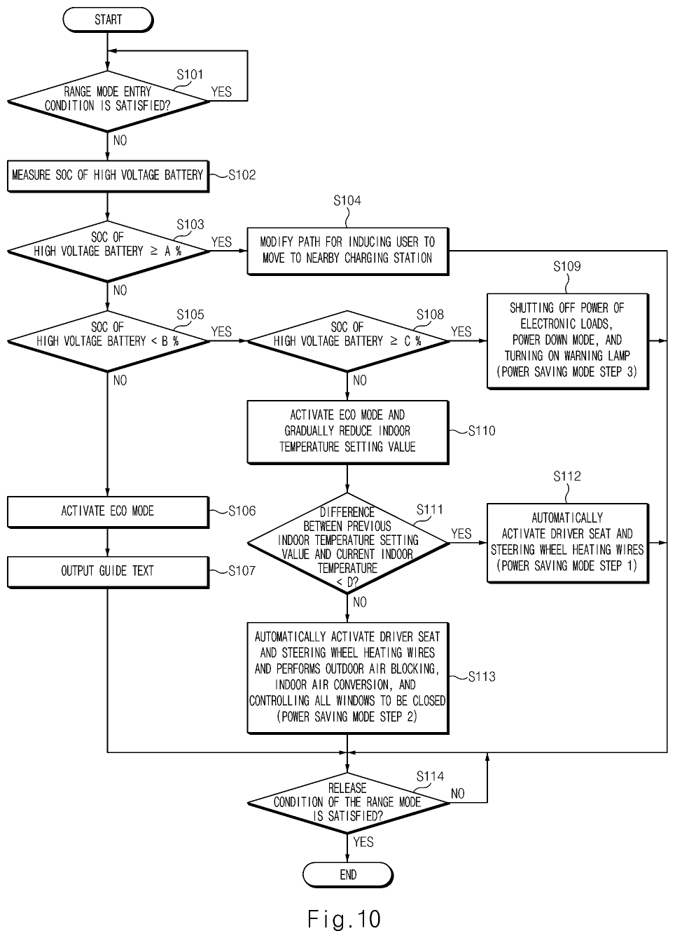

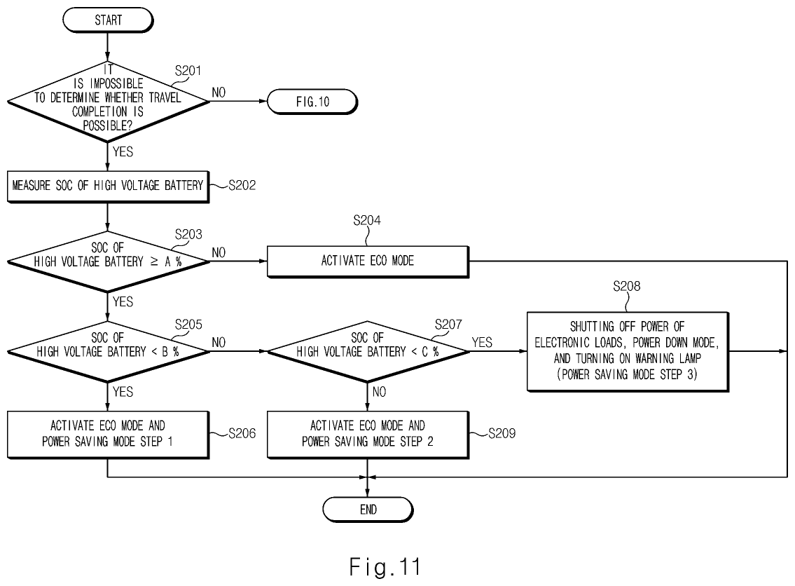

Hereinafter, a mileage management method according to an exemplary embodiment of the present disclosure will be described in detail with reference to FIG. 10 and FIG. 11. FIG. 10 illustrates a flowchart for describing a mileage management method for an electric vehicle according to exemplary embodiment of the present disclosure. FIG. 11 illustrates a flowchart for describing a mileage management method for an electric vehicle when it is impossible to determine whether or not a travel is completed d according to exemplary embodiment of the present disclosure.

Hereinafter, it is assumed that the mileage management apparatus 100 for the electric vehicle of FIG. 1 performs the processes of FIG. 10 and FIG. 11. Furthermore, in the description of FIG. 10, operations referred to as being performed by a device may be understood as being controlled by the processor 150 of the mileage management apparatus 100.

Referring to FIG. 10, the mileage management apparatus 100 determines whether a range mode entry condition is satisfied (S101). The range mode is a mode to drive with a priority on mileage improvement over other electronic functions (heater, etc.). Accordingly, when a user selects the driving mode as the range mode, the mileage management apparatus 100 may enter the range mode.

Furthermore, when driving autonomously or when a destination is set via navigation (driving in a sports mode or a comfort mode), the mileage management apparatus 100 may be configured to determine whether it is possible to complete a travel to the destination by use of an estimated mileage (km) based on an SOC value of a high voltage battery and an actual remaining distance (km) to the destination. For example, the mileage management apparatus 100 may be configured to determine that the completion of the travel is impossible when the expected mileage based on the SOC value of the high voltage battery is smaller than the actual remaining distance to the destination. Accordingly, when it is determined that the completion is impossible, the mileage management apparatus 100 automatically switches the driving mode to the range mode.

Furthermore, when not driving autonomously but driving is performed with a destination set through navigation (driving in a sports mode or a comfort mode), the mileage management apparatus 100 may be configured to determine whether it is possible to complete a travel to the destination by use of an estimated mileage (km) based on an SOC value of a high voltage battery and an actual remaining distance (km) to the destination, and when it is determined to complete the travel, may automatically switches the driving mode to the range mode.

Furthermore, when the vehicle is not driving autonomously and a destination is not set through navigation, it is impossible to determine whether or not to complete the travel. Accordingly, when it is not possible to determine whether or not to complete the travel, the mileage management apparatus 100 may enter the range mode when the range mode is manually set by a user.

Accordingly, when automatically entering the range mode, the mileage management apparatus 100 displays a state in which the completion of the travel is impossible as a pop-up window on a screen of the interface device 140 so that a user may intuitively recognize the impossible state.

Hereinafter, a process for driving in the range mode will be described.

The mileage management apparatus 100 measures the SOC value of the high voltage battery (S102).

The mileage management apparatus 100 determines whether the SOC value of the high voltage battery is equal to or greater than a first reference value A (S103). In the instant case, the first reference value A may be set in advance by an experimental value, for example, it may be 50%.

When the SOC value of the high voltage battery is greater than or equal to the first reference value A, the mileage management apparatus 100 may modify a path for inducing the user to move to a nearby charging station (S104).

When the SOC value of the high voltage battery is smaller than the first reference value A, the mileage management apparatus 100 may be configured to determine whether the SOC value of the high voltage battery is smaller than a predetermined second reference value B (S105). In the instant case, the second reference value B may be previously set by an experimental value, may be set to a value which is smaller than the first reference value A, and may be, e.g., 30%.

Accordingly, when the SOC value of the high voltage battery is not smaller than the second reference value B, that is, when the SOC value of the high voltage battery is equal to or greater than the predetermined second reference value B and less than the first reference value A, the mileage management apparatus 100 activates the economical mode (S106). In the instant case, in the economical mode, drivetrain efficiency control such as braking control, regenerative braking, torque distribution, vehicle speed limit (e.g., 90 to 120 kph), and acceleration performance down may be performed, and power consumption of high voltage loads, such as HVAC off, may be limited. Accordingly, the mileage management apparatus 100 outputs a guide text guiding that the economical mode is activated (S107).

On the other hand, when the SOC value of the high voltage battery is smaller than the second reference value B in step S105, the mileage management apparatus 100 determines whether the SOC value of the high voltage battery is smaller than a predetermined third reference value C (S108). In the instant case, the third reference value C may be previously set by an experimental value, may be set to a value which is smaller than the second reference value B, and may be, e.g., 10%.

Accordingly, when the SOC value of the high voltage battery is smaller than the third reference value C, the SOC value of the high voltage battery is very insufficient, and thus step 3 of the power saving mode are performed, such as shutting off power of electronic loads (seat heating wire, steering wheel heating wire, etc.), putting a heater, etc. Into a power down mode, and turning on a warning lamp (S109).

In the meantime, when the SOC value of the high voltage battery is greater than or equal to the third reference value C and smaller than the second reference value B, the mileage management apparatus 100 activates the economical mode and lowers an indoor temperature setting value step by step (S110). For example, the mileage management apparatus 100 may gradually decrease the indoor temperature setting value by −1° C. to −5° C. In the instant case, the mileage management apparatus 100 may control a vehicle indoor temperature to follow the downwardly set indoor temperature setting value through map-based control depending on the downwardly set indoor temperature setting value.

Accordingly, the mileage management apparatus 100 determines whether a difference between a previous indoor temperature setting value and a current indoor temperature is smaller than a predetermined reference value D (S111). In the instant case, the predetermined reference value D may be preset by an experimental value, and may be, e.g., 5 degrees. In the instant case, the previous indoor temperature setting value refers to a value set by a user at beginning of driving as the indoor temperature setting value before lowering it in step S110. Accordingly, when the indoor temperature setting value is lowered to preserve the SOC value of the high voltage battery but the indoor temperature continues to drop, satisfaction of a user inside the vehicle decreases, and thus it is necessary to recognize and respond to a degree of decrease in the indoor temperature, and hereinafter, the response depending on downward conduction of the indoor temperature will be described.

When the difference between the previous indoor temperature setting value and the current indoor temperature is smaller than the predetermined reference value D, a driver seat heating wire and a steering wheel heating wire are automatically activated as step 1 of the power saving mode (S112).

On the other hand, when the difference between the previous indoor temperature setting value and the current indoor temperature is equal to or greater than the predetermined reference value D, the mileage management apparatus 100 is configured to control warmth in the vehicle to be maintained by not only automatically activating the driver seat and steering wheel heating wires but also outdoor air blocking, indoor air conversion, controlling all windows of the vehicle to be closed, etc. As the second step of the power saving mode (S113). In the instant case, amounts of heat generated by the driver seat and the steering wheel heating wires may be higher than those of step 1 of the power saving mode.

In FIG. 10, an example where step 1 of power saving mode is performed when the current indoor temperature is smaller than 5° C. which is lower than the previous indoor temperature setting value and step 2 of power saving mode is performed when the current indoor temperature is 5° C. or more lower than the previous indoor temperature setting value is disclosed, but the present disclosure is not limited thereto.

That is, when there is a difference between the current indoor temperature and the previous indoor temperature setting value by 3° C. or more and smaller than 5° C., step 1 of power saving mode may be performed, when the current indoor temperature is 5° C. or more lower than the previous indoor temperature setting value, and step 2 of the power saving mode may be performed, when a difference between the current indoor temperature and the previous indoor temperature setting value is smaller than 3° C., only the economical mode may be performed without performing the power saving mode.

Accordingly, according to an exemplary embodiment of the present disclosure, a user to feel cold when the current indoor temperature drops by more than −3° C. by activating the economical mode by entering the range mode and lowering the indoor temperature setting value, and thus step 1 of the power saving mode for conductive heat transfer to a user is performed, and the user may feel a lot of cold when the current indoor temperature drops by more than −3° C., and thus the vehicle interior temperature is prevented from lowering further by performing step 2 of the power saving mode.

Thereafter, the mileage management apparatus 100 determines whether a release condition of the range mode is satisfied (S114), and end portions it when the release condition of the range mode is satisfied.

The mileage management apparatus 100 automatically releases the range mode when a user manually raises an air conditioning temperature (air conditioning controller Manual on), opens a window (window switch input on), turns on a defrost (blower speed up), or operates a heating, ventilation, and air conditioning (HVAC)/heating wire/opening and closing switch

Furthermore, the mileage management apparatus 100 may release the range mode when the user manually changes the driving mode to the comfort mode or the sports mode.

Hereinafter, an example in which the range mode is performed using only the SOC value of the high voltage battery when it is impossible to determine whether the travel is completed will be described with reference to FIG. 11. Furthermore, Table 1 below is a table summarizing the range mode using only the SOC value of the high voltage battery when it is impossible to determine whether the travel is completed. This will be described with reference to FIG. 11 and Table 1.

TABLE 1

| | | Range mode | | |
|---|---|---|---|---|
| | | | | [Power saving |
| | | | | mode_Step 2] |
| | | | | Heating |
| | Determination | | [Power saving | temperature: above −5 |
| | whether it is | [ECO | mode_Step 1] | degrees |
| | possible/impossible | Drive] | Heating | And sheet/steering |
| SOC value | to complete travel | Vehicle | temperature: −3 | wheel heating wire |
| of battery | to destination | speed limit | degree | assistance |
| More than | Impossible to | Controllable | Disable | Disable |
| 50% | determine | | | |
| 30% to | Impossible to | 90 to 120 | Controllable | Disable |
| 50% | determine | kph | | |
| 10% to | Impossible to | Less than | Controllable | Controllable |
| 29% | determine | 90 kph | | |
| Less than | (Warning light) | Power | Air conditioning | Air conditioning & |
| 10% | | Down | OFF | heating wire OFF |

Referring to FIG. 11 and Table 1, the mileage management apparatus 100 determines whether it is possible to determine whether it is possible to complete the travel (S201). When a destination is not set in a navigation system, the mileage management apparatus 100 may be configured to conclude that the processor cannot determine whether the vehicle can complete the travel to the destination.

When it is impossible to determine whether the travel may be completed, the mileage management apparatus 100 measures the SOC value of the high voltage battery (S202).

The mileage management apparatus 100 determines whether the SOC value of the high voltage battery is equal to or greater than a first reference value A (S203).

When the SOC value of the high voltage battery is greater than or equal to the first reference value A, the mileage management apparatus 100 may activate the economical mode (S204). In the instant case, in the economical mode, power consumption of high voltage loads such as vehicle speed limit (e.g., 90 to 120 kph), brake control, HVAC off, etc. is limited. The mileage management apparatus 100 may automatically turn on or off a unit function of a high voltage heating load or perform continuous control based on a power supply priority (weight).

On the other hand, when the SOC value of the high voltage battery is smaller than the first reference value A, the mileage management apparatus 100 may be configured to determine whether the SOC value of the high voltage battery is smaller than a predetermined second reference value B (S205).

Accordingly, when the SOC value of the high voltage battery is not smaller than the second reference value B, that is, when the SOC value of the high voltage battery is equal to or greater than the predetermined second reference value B and less than the first reference value (A), the mileage management apparatus 100 activates the economical mode and step 1 of the power saving mode (S206). In the instant case, in step 1 of the power saving mode, driver seat and steering wheel heating wires are automatically activated to provide conductive heat to a user so that the user feels less cold. That is, the mileage management apparatus 100 may perform a control based on a power saving heating target temperature map, and may perform power distribution control on a heating wire load to keep a user warm when the indoor temperature is lowered by more than a predetermined value.

On the other hand, when the SOC value of the high voltage battery is smaller than the second reference value B in step S205, the mileage management apparatus 100 determines whether the SOC value of the high voltage battery is smaller than a predetermined third reference value C (S207).

Accordingly, when the SOC value of the high voltage battery is smaller than the third reference value C, the SOC value of the high voltage battery is very insufficient, and thus step 3 of the power saving mode are performed, such as shutting off power of electronic loads (seat heating wire, steering wheel heating wire, etc.), entering a power down mode, and turning on a warning lamp (S208).

In the meantime, when the SOC value of the high voltage battery is greater than or equal to the third reference value C and smaller than the second reference value B, the mileage management apparatus 100 activates the economical mode and step 2 of the power saving mode in S209. In step 2 of the power saving mode, conduction heat is transferred to a user by automatically activating driver seat and steering wheel heating wires, outdoor air blocking, indoor air conversion, controlling all windows of the vehicle to be closed, etc. are performed to perform control for maintaining warmth in the vehicle. However, even when being performing step 1 of the power saving mode, step 2 of the power saving mode, etc., when an air conditioning temperature and a number of heating wires (levels) are manually changed by a user, the mileage management apparatus 100 may automatically step 1 of the power saving mode and step of the power saving mode.

Accordingly, according to an exemplary embodiment of the present disclosure, when a destination is set during autonomous driving in winter, a user may intuitively determine whether or not a travel may be completed by determining whether it is possible to complete the travel to the destination based on the SOC value of the high voltage battery and displaying a state where it is impossible to complete the travel through a pop-up window when it is impossible to the complete the travel.

Furthermore, according to an exemplary embodiment of the present disclosure, when it is impossible to complete the travel, the economical mode for preserving the SOC value of the high voltage battery may be performed by entering a driving mode of the vehicle into the range mode.

Furthermore, according to an exemplary embodiment of the present disclosure, when an indoor temperature of the vehicle is lowered by performing the economical mode, the power saving mode (steps 1 and 2) may be performed to maintain a user body temperature. Furthermore, according to an exemplary embodiment of the present disclosure, when the SOC value of the high voltage battery is in a very low state, step 3 of the power saving mode may be performed.

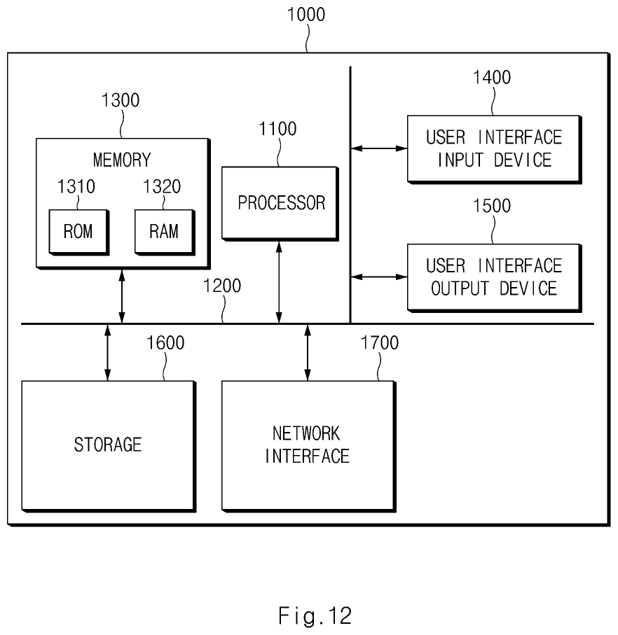

FIG. 12 illustrates a computing system according to an exemplary embodiment of the present disclosure.

Referring to FIG. 12, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A mileage management apparatus for a vehicle, the mileage management apparatus comprising:
a processor configured to determine whether the vehicle can complete a travel to a destination thereof by use of a mileage based on a state of charge (SOC) value of a battery, to limit power consumption of a load having a voltage higher than a predetermined voltage when the processor concludes that the vehicle cannot complete the travel, and to drive a load having a voltage lower than the predetermined voltage depending on a degree of a decrease in an indoor temperature of the vehicle to provide heat to a user, and
an interface device communicatively connected to the processor and configured to display whether the completion of the travel is possible.

2. The mileage management apparatus of claim 1, wherein the interface device is further configured to output a possibility of the completion in a form of a pop-up message.

3. The mileage management apparatus of claim 1, wherein the processor is further configured to enter a range mode for increasing a mileage based on the SOC value of the battery when the processor concludes that the completion of the travel is impossible.

4. The mileage management apparatus of claim 3, wherein during autonomous driving of the vehicle or when the destination of the vehicle is set, the processor is further configured to conclude that the vehicle cannot complete the travel when the mileage determined based on the SOC value of the battery is shorter than a distance to the destination.

5. The mileage management apparatus of claim 3, wherein, during manual driving or when the destination is not set, the processor is further configured to conclude that the processor cannot determine whether the vehicle can complete the travel to the destination.

6. The mileage management apparatus of claim 3, wherein, during manual driving or when the destination is not set, the processor is further configured to enter the range mode when a driving mode is set as the range mode and inputted by the user.

7. The mileage management apparatus of claim 3, wherein, when entering the range mode and the SOC value of the battery is greater than or equal to a first reference value, the processor is further configured to correct a path of the vehicle to enable the vehicle to move to a charging station.

8. The mileage management apparatus of claim 7, wherein the processor is further configured to activate an economical mode that limits the power consumption of the load having the voltage higher than the predetermined voltage when the SOC value of the battery is equal to or greater than a second reference value which is smaller than the first reference value.

9. The mileage management apparatus of claim 8, wherein, when the SOC value of the battery is smaller than the second reference value and smaller than a third reference value which is smaller than the second reference value, the processor is further configured to cut off power of an electronic load among the load having the voltage higher than the predetermined voltage and the load having the voltage lower than the predetermined voltage, and to turn on a warning lamp of the vehicle.

10. The mileage management apparatus of claim 9, wherein, when the SOC value of the battery is greater than or equal to the third reference value and smaller than the second reference value, which is smaller than the first reference value, the processor is further configured to activate the economical mode, and to decrease an indoor temperature setting value.

11. The mileage management apparatus of claim 10, wherein, when a current indoor temperature is lower than a previously set indoor temperature setting value by less than a predetermined reference value, the processor is further configured to perform step 1 of a power saving mode of automatically activating a driver seat heating wire and a steering wheel heating wire.

12. The mileage management apparatus of claim 10, wherein when a current indoor temperature is lower than a previously set indoor temperature setting value by equal to or greater than a predetermined reference value, the processor is further configured to:
automatically activate a driver seat heating wire and a steering wheel heating wire; and
perform step 2 of a power saving mode of performing at least one of outdoor air blocking, indoor air conversion, and controlling all windows of the vehicle to be closed.

13. The mileage management apparatus of claim 3, wherein, during an operation of the range mode, the processor is further configured to release the range mode when manual operation of at least one of an operation of an air conditioning controller, window opening, turning-on of a defrost, changing of a driving mode is performed by the user.

14. The mileage management apparatus of claim 1, wherein the limiting of the power consumption of the load having the voltage higher than the predetermined voltage includes at least one of a vehicle speed limit, a braking control, and an air conditioner off control.

15. The mileage management apparatus of claim 1, wherein the load having the voltage lower than the predetermined voltage includes at least one of a front deicer, a steering wheel heater, a seat warmer, a window heating wire, and a sunroof glass heating wire.

16. The mileage management apparatus of claim 1, wherein, when the processor concludes that the processor cannot determine whether the vehicle can complete the travel based on the SOC value of the battery, the processor is further configured to determine a stage of the range mode for increasing the mileage based on the SOC value of the battery.

17. The mileage management apparatus of claim 12, wherein the processor is further configured to:
limit a vehicle speed when the SOC value of the battery is greater than or equal to a first reference value;
limit the vehicle speed and decrease an indoor temperature setting value when the SOC value of the battery is smaller than the first reference value and greater than or equal to a second reference value which is smaller than the first reference value; and
limit the vehicle speed and decrease the indoor temperature setting value, but activate seat heating and steering wheel heating when the SOC value of the battery is smaller than the second reference value and greater than or equal to a third reference value which is smaller than the second reference value.

18. The mileage management apparatus of claim 3, wherein, when entering the range mode, the processor is further configured to turn off air conditioning of second and third rows of the vehicle, and to drive air conditioning of a driver seat in the vehicle.

19. The mileage management apparatus of claim 3, wherein the interface device is further configured to:
display an indoor temperature setting value before entering the range mode; and
remove the displaying of the indoor temperature setting value after entering the range mode.

20. A mileage management method for a vehicle, the method comprising:
determining, by a processor, whether the vehicle can complete a travel to a destination thereof by use of a mileage based on a state of charge (SOC) value of a battery in the vehicle;
limiting, by the processor, power consumption of a load having a voltage higher than a predetermined voltage when the processor concludes that the vehicle cannot complete the travel; and
driving, by the processor, a load having a voltage lower than the predetermined voltage depending on a degree of a decrease in an indoor temperature of the vehicle to provide heat to a user,
